(19) United States
(12) Patent Application Publication
(10) Pub. No.: US 2007/0089976 A1
(43) Pub. Date: Apr. 26, 2007

(54) Push button device

(75) Inventors: Takato Oda, Echizen-city (JP); Seigo Ohkubo, Echizen-city (JP); Yusuke Kataoka, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/582,484

(22) Filed: Oct. 18, 2006

(30) Foreign Application Priority Data
Oct. 20, 2005 (JP) 2005-305199

(51) Int. Cl. H01H 13/70

(52) U.S. Cl. 200/343

(57) ABSTRACT

Damage to a part when assembling a substrate from behind a casing mounted with push buttons is prevented. When a circuit substrate is mounted in a casing to which a push button is attached, a circuit substrate is inserted along a guide groove of the push button. At this time, the contact section is pushed by the circuit substrate and the circuit substrate is engaged with the contact section with a second hinge section deflected. This causes the circuit substrate to be parallel with a pushing section with a tiny gap in between and a pushing operation of an operation button deforms a first hinge section and the pushing section turns ON/OFF a switch.

The present application is based on and claims priority of Japanese patent application No. 2005-305199 filed on Oct. 20, 2005, the entire contents of which are hereby incorporated by reference.

### BACKGROUND OF THE INVENTION

1. Field of the Invention

The present invention relates to a push button device used for an electronic apparatus such as a television receiver and video reproducing device, and more particularly, to a push button device constructed so that a pushing direction in which the push button device is operated is perpendicular to a switch pushing direction.

2. Description of the Related Art

Conventionally, push buttons for operating a plurality of switches are built in on the front face of a casing of a television receiver or the like for use in processing or control of various sections of the television receiver. As such a push button device used for an electronic apparatus, for example, Japanese Patent Laid-Open Publications No. 2002-334632, Japanese Patent Laid-Open Publication No. 2003-168342 and Japanese Utility Model Registration No. 3110012 disclose a push button device constructed in such a way that an end of each push button is fixed onto the inside of the front face of its casing, each operation button formed at a free end is disposed as to protrude out of each insertion hole formed on the front face of the casing, a pushing section for pushing each switch is disposed so as to protrude from the inner surface of the pushing button and the pushing direction in which the operation button is operated is perpendicular to the pushing direction of the switch so that the switch is turned ON/OFF by the pushing section through the pushing operation of the operation button.

Such a push button device is a single-piece molded product made of synthetic resin or the like having a simple structure with an end of the push button device fixed and attached to the front face of the casing and provides excellent assembly operability, but on the other hand when the gap between the pushing section for pushing the switch and a circuit substrate in which the switch is mounted is narrow, the pushing section contacts the circuit substrate in assembling the push button device and the like, causing problems such as damage to the push button device or circuit substrate.

### SUMMARY OF THE INVENTION

The present invention has been implemented in view of the above described problems and it is an object of the present invention to provide a push button device capable of preventing damage to components when a circuit substrate is mounted.

The push button device according to a first aspect of the present invention is a push button device having a circuit substrate mounted with switches placed substantially horizontally inside a casing, constructed so that a frame for push buttons is fixed onto a front face of the casing, operation buttons are continuously placed from the frame by means of first hinges, the operation buttons are protruded outward through insertion holes formed in the front face of the casing and the operation buttons are pushed and the switches are operated by pushing sections formed on an inner surface side of the operation buttons, wherein the frame comprises a fixed section to be fixed to the inner surface side of the front face of the casing, a contact section that can contact the circuit substrate is formed on the inner surface of the frame, the fixed section and the frame are continuously placed by means of an elastically deformable second hinge section, and the contact section is engaged with the circuit substrate with the second hinge section being elastically deformed to deflect.

According to the configuration of the first aspect of the present invention, when the circuit substrate is mounted from behind the push buttons, the operation buttons are formed with the second hinge section elastically deformed beforehand so that the second hinge section is deformed by pushing the contact section through the circuit substrate and it is possible to mount the circuit substrate without the switches mounted on the circuit substrate contacting the pushing sections.

The push button device according to a second aspect of the present invention is the push button device according to the first aspect of the present invention, wherein a rib making up the contact section is provided so as to protrude from the back of the frame and the rib is engaged with the circuit substrate with the circuit substrate inserted into a guide groove formed in the rib.

According to the configuration of the second aspect of the present invention, when the push buttons are mounted, the circuit substrate is inserted into the guide groove formed in the rib and the circuit substrate is positioned with respect to the push buttons by the circuit substrate and guide groove.

The push button device according to a third aspect of the present invention is the push button device according to the second aspect of the present invention, wherein a stopper is formed in the casing, the stopper contacts the frame when the rib is engaged with the circuit substrate to regulate the deformation of the second hinge section.

According to the third aspect of the present invention, the push buttons during the mounting of the circuit substrate are positioned by contact between the frame for the push buttons and stopper.

The push button device according to a fourth aspect of the present invention is the push button device according to the third aspect of the present invention, wherein when the rib contacts the circuit substrate, the frame is pushed by the circuit substrate to come into contact with the stopper, the rib contacts the bottom of the casing and the pushing section and circuit substrate are positioned and held substantially parallel to each other.

According to the configuration of the fourth aspect of the present invention, when the rib comes into contact with the circuit substrate, the pushing section which pushes the switch is inclined upward at its tip with respect to the circuit substrate and the circuit substrate is separated from the pushing section, and therefore it is possible to suppress interference with the pushing section of the push button during mounting, and the tip of the pushing section descends after the mounting, comes closer to the circuit substrate and the pushing section becomes parallel to the circuit substrate, and therefore it is not necessary to set a wider stroke of the operation button than necessary.

The push button device according to a fifth aspect of the present invention is the push button device according to any one of the second to fourth aspects of the present invention, wherein the guide groove is formed so as to have a wider insertion side which receives the circuit substrate and tapered toward the back.

According to the configuration of the fifth aspect of the present invention, when the push button is mounted, the circuit substrate is guided into the guide groove formed in the rib.

### BRIEF DESCRIPTION OF THE DRAWINGS

FIG. 1 is a perspective view of a push button showing an embodiment of the present invention;

FIG. 2 is a front view of the push button showing the embodiment of the present invention;

FIG. 3 is a side view of the push button showing the embodiment of the present invention;

FIG. 4 is a cross-sectional view along a line A-A in FIG. 2 showing the embodiment of the present invention;

FIG. 5 is a cross-sectional view along a line B-B in FIG. 2 showing the embodiment of the present invention; and

FIG. 6 is a cross-sectional view showing a mounting state of the push button of the embodiment of the present invention; FIG. 6A shows a state before mounting and FIG. 6B shows a state after mounting.

### DETAILED DESCRIPTION OF THE PREFERRED EMBODIMENTS

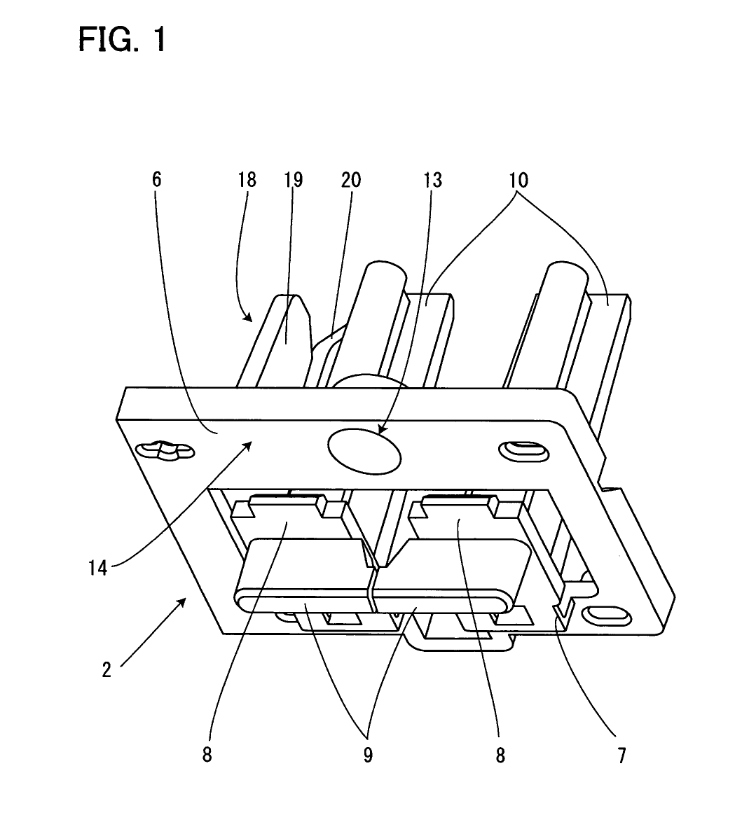

Hereinafter, as the best mode for implementing the present invention, an embodiment will be explained with reference to FIG. 1 to FIG. 6. It goes without saying that the present invention is also easily applicable to cases other than that explained in the embodiment within a range not departing from the essence of the present invention.

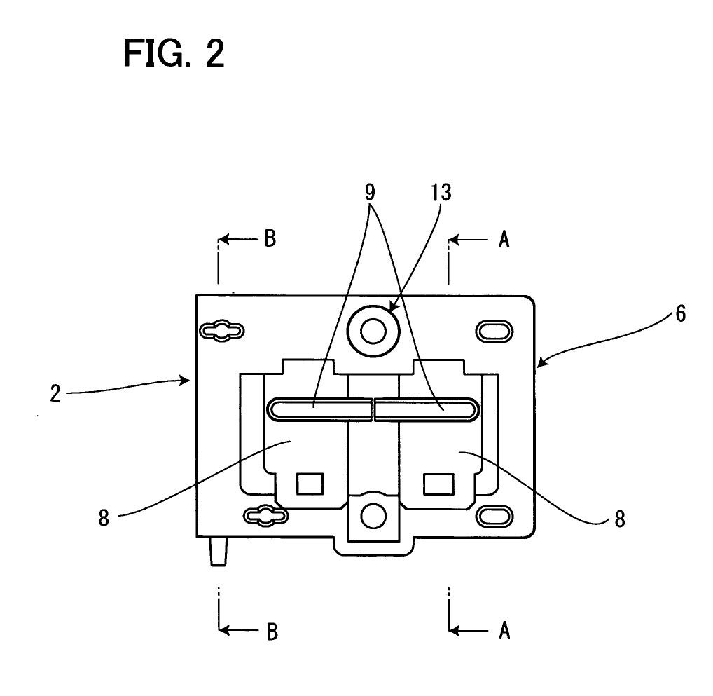

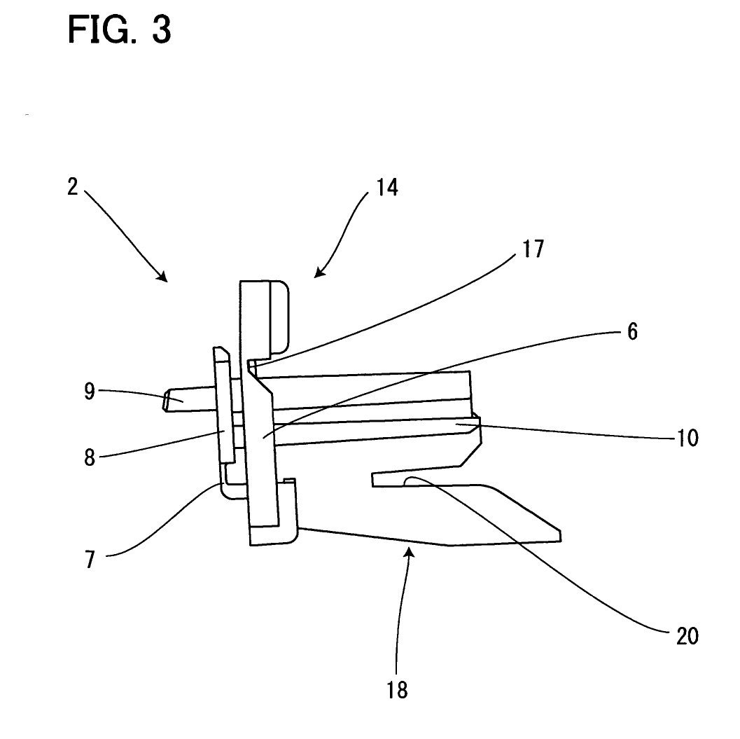

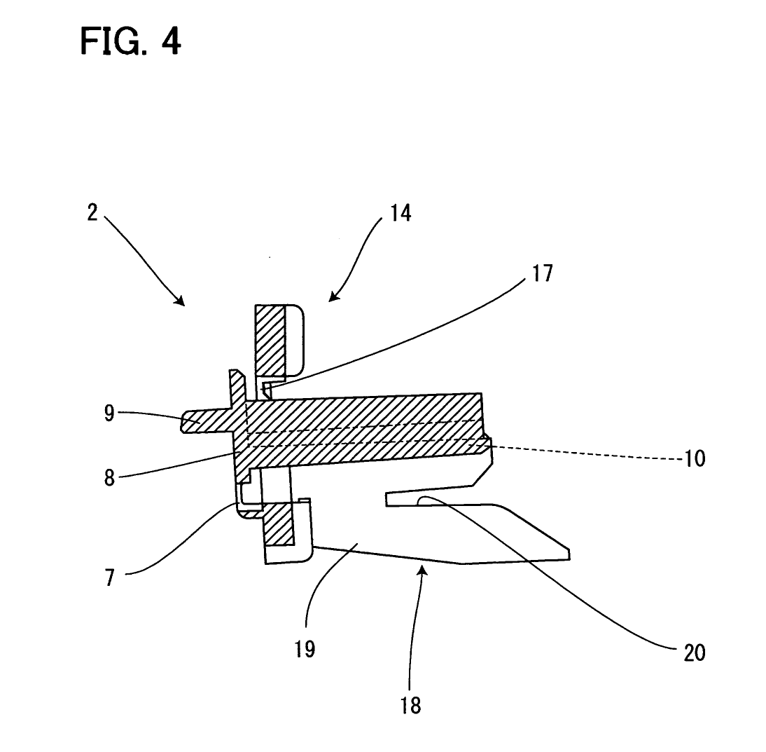

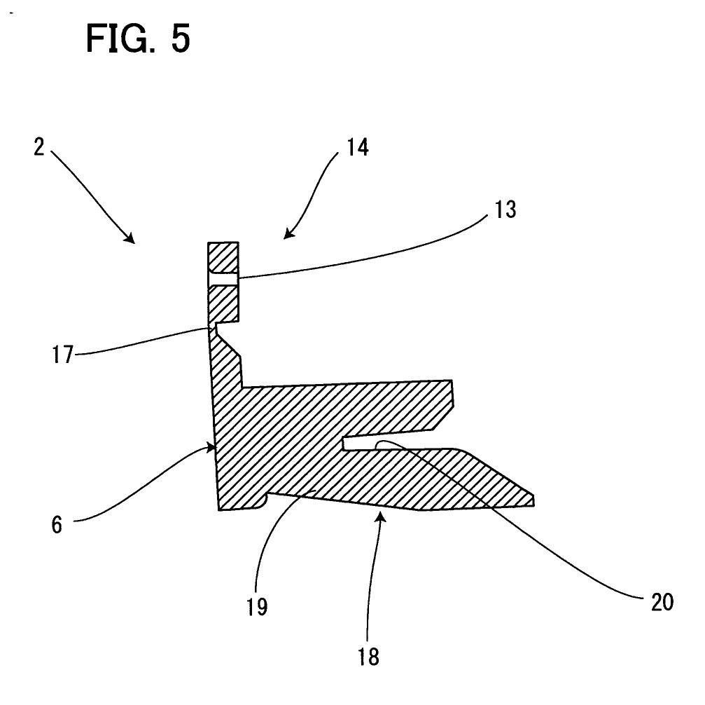

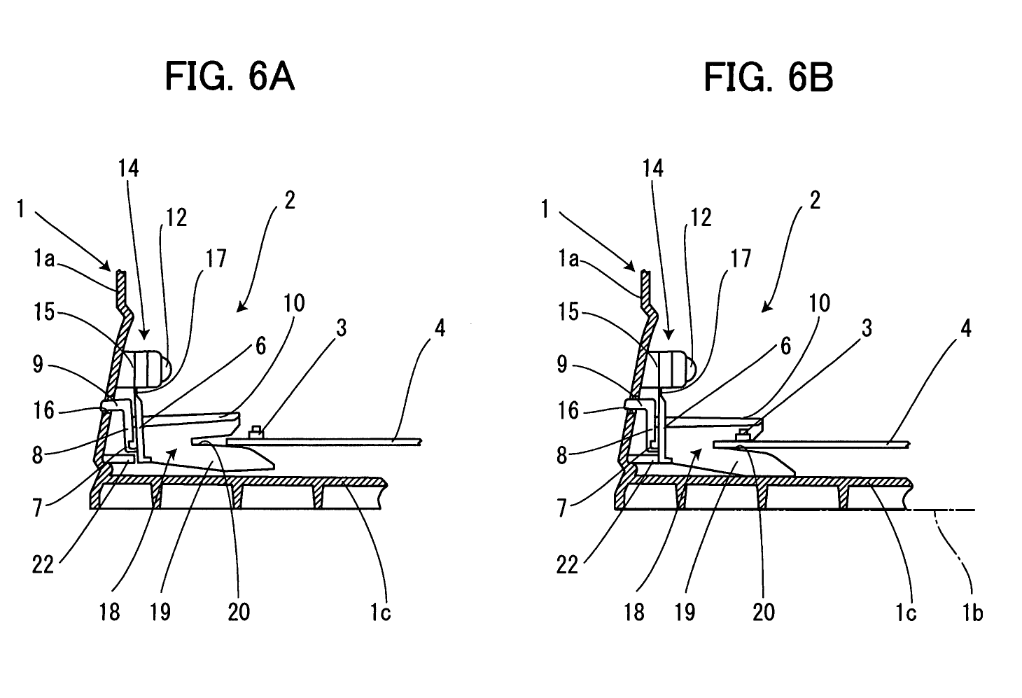

FIG. 1 to FIG. 6 show an embodiment of the present invention, FIG. 1 is a perspective view of a push button, FIG. 2 is a front view of the push button, FIG. 3 is a side view of the push button, FIG. 4 is a cross-sectional view along a line A-A in FIG. 2, FIG. 5 is a cross-sectional view along a line B-B in FIG. 2 and FIG. 6 is a cross-sectional view showing a mounting state of the push button. In the same figure, reference numeral 1 denotes a casing of an electronic apparatus such as a television receiver and a plurality of push buttons 2 for selecting various sections and performing switching operations or the like of the television receiver are arranged in parallel on the front face 1a of the casing 1. Inside the casing 1, a circuit substrate 4 for mounting a plurality of switches 3 corresponding to the respective push buttons 2 is disposed horizontally in parallel with a bottom 1b of the casing 1.

The push button 2 is a single-piece molded product made of synthetic resin and is formed integral with a flat support section 8 through a thin first hinge section 7 which is bent L-figured from the front lower part of a wholly rim-shaped frame 6. An operation button 9 is formed so as to protrude from the front face of this support section 8 and a pushing section 10 whereby the switch 3 is pushed is provided so as to protrude from the back of the support section 8. In this embodiment, a pair of left and right support sections 8 including the operation buttons 9 and pushing sections 10 are formed as one piece. Furthermore, insertion holes 16 corresponding to the operation buttons 9 are formed in the front face 1a of the casing 1, the operation buttons 9 are protruded out of the insertion holes 16 so as to be exposed outward and pushing the operation button 9 deflects the first hinge section 7 causing the pushing section 10 to turn ON/OFF the switch 3.

A fixed section 14 provided with a hole 13 through which a screw 12 passes is formed in an upper part of the frame 6, a boss section 15 is provided so as to protrude from the inner surface of the front face 1a of the casing 1 in correspondence with the hole 13, the screw 12 inserted into the hole 13 is screwed into the boss section 15 and the push button 2 with the operation button 9 protruding out of the insertion hole 16 formed on the front face 1a of the casing 1 is thereby fixed to the inner surface of the front face 1a of the casing 1. Furthermore, a thin second hinge section 17 is formed between the fixed section 14 of the frame 6 and support section 8 and a contact section 18 which can contact the circuit substrate 4 is formed on the back of the support section 8. This contact section 18 is made up of a rib 19 which protrudes backward from the back of the support section 8 and inserting the circuit substrate 4 into a guide groove 20 formed in this rib 19 causes the circuit substrate 4 to push the contact section 18, which deflects the second hinge section 17 causing the fixed section 14 to be positioned substantially in line with the support section 8. That is, when no stress is applied from the circuit substrate 4 to the contact section 18, the support section 8 is inclined backward and connected to the fixed section 14 and the pushing section 10 which perpendicularly protrudes from the back of the support section 8 is inclined upward at its tip with respect to the circuit substrate 4.

As described above, according to this embodiment, the operation button 9 of the push button 2 is inserted from the insertion hole 16 formed in the front face 1a of the casing 1 as shown in FIG. 6A, the screw 12 is screwed into the boss section 15 formed in the inner surface of the front face 1a of the casing 1 through the hole 13 formed in the frame 6 of the push button 2 and the frame 6 is fixed to the inner surface of the front face 1a of the casing 1. At this time, when no stress is applied from the circuit substrate 4 to the rib 19 which is the contact section 18, the support section 8 is inclined backward and connected to the fixed section 14 and the pushing section 10 perpendicularly protruding from the back of the support section 8 is inclined upward at its tip with respect to the circuit substrate 4. After this, the circuit substrate 4 is built in the casing 1 to which the push button 2 is attached and the circuit substrate 4 fixed to the casing 1 is thereby guided into the guide groove 20 formed in the rib 19 which protrudes behind the frame 6. After this, when the circuit substrate 4 is pushed against the casing 1, the contact section 18 is pushed by the circuit substrate 4, and the second hinge section 17 is deflected as shown in FIG. 6B with the fixed section 14 positioned substantially in line with the support section 8, the support section 8 contacts a stopper 22 of the front face 1a of the casing 1 and at the same time the bottom of the rib 19 contacts a bottom wall 1c formed in the casing 1. Thus, when the second hinge section 17 is deflected, the fixed section 14 is positioned substantially in line with the support section 8, the circuit substrate 4 mounted with the switch 3 becomes parallel to the pushing section 10 and the support section 8 is positioned with the circuit substrate 4 elastically engaged with the guide groove 20 by means of an elastic force of restitution. When the operation button 9 protruding from the insertion hole 16 is pushed, the first hinge section 7 is deformed and the pushing section 10 causes the switch 3 to turn ON/OFF. When the operation button 9 is pushed, the support section 8 contacts the fixed section 14, and therefore the operation button 9 is never pushed any further.

As shown above, in this embodiment, when the circuit substrate 4 is mounted in the casing 1 to which the push button 2 is fixed, the circuit substrate 4 pushes the contact section 18 and the second hinge section 17 is deformed so that the circuit substrate 4 becomes parallel to the pushing section 10, and therefore when no stress is applied from the circuit substrate 4 to the rib 19, which is the contact section 18, the pushing section 10 which pushes the switch 3 is inclined upward at its tip with respect to the circuit substrate 4 and the circuit substrate 4 is separated from the pushing section 10. This makes it possible to prevent damages to the rib 19 or circuit substrate 4 due to interference between the rib 19 of the push button 2 and circuit substrate 4 during assembly, and arrange the circuit substrate 4 and pushing section 10 parallel to each other with a tiny gap after assembly and eliminates the necessity for setting a wider stroke of the operation button 9 than necessary. Furthermore, since the circuit substrate 4 engages with the guide groove 20 of the contact section 18 with the second hinge section deformed, it is possible to suppress backlash of the circuit substrate 4 by means of an elastic force of restitution of the second hinge section 17.

The embodiment of the present invention has been explained in detail so far, but the present invention is not limited to the foregoing embodiment and can be implemented modified in various ways within a range not departing from the essence of the present invention. For example, the above described embodiment has explained the television receiver as an example, but without being limited to this, the present invention is applicable to various other electronic apparatuses.

The effects of the present invention are as follows.

According to the push button device of a first aspect of the present invention, it is possible to mount the circuit substrate with the second hinge section elastically deformed beforehand without the switch mounted on the circuit substrate contacting the pushing section.

According to the push button device of a second aspect of the present invention, it is possible to reliably position the circuit substrate through the guide groove formed in the rib of the push button.

According to the push button device of a third aspect of the present invention, it is possible to reliably position the push button with the circuit substrate elastically engaged with the guide groove.

According to the push button device of a fourth aspect of the present invention, it is possible to suppress interference between the pushing section and circuit substrate during mounting, prevent damages to the push button or circuit substrate and set a narrow stroke when operating the push button.

According to the push button device of a fifth aspect of the present invention, it is possible to reliably guide the circuit substrate into the guide groove formed in the rib.

What is claimed is:

1. A push button device having a circuit substrate mounted with switches placed substantially horizontally inside a casing, constructed so that a frame for push buttons is fixed onto a front face of the casing, operation buttons are continuously placed from the frame by means of first hinges, the operation buttons are protruded outward through insertion holes formed in the front face of the casing and the operation buttons are pushed and the switches are operated by pushing sections formed on an inner surface side of the operation buttons,
wherein the frame comprises a fixed section to be fixed to the inner surface side of the front face of the casing,
a contact section that can contact the circuit substrate is formed on the inner surface of the frame,
the fixed section and the frame are continuously placed by means of an elastically deformable second hinge section, and
the contact section is engaged with the circuit substrate with the second hinge section being elastically deformed to deflect.

2. The push button device according to claim 1, wherein a rib making up the contact section is provided so as to protrude from the back of the frame and the rib is engaged with the circuit substrate with the circuit substrate inserted into a guide groove formed in the rib.

3. The push button device according to claim 2, wherein a stopper is formed in the casing, the stopper contacts the frame when the rib is engaged with the circuit substrate to regulate the deformation of the second hinge section.

4. The push button device according to claim 2, wherein the guide groove is formed so as to have a wider insertion side which receives the circuit substrate and tapered toward the back.

5. The push button device according to claim 3, wherein when the rib contacts the circuit substrate, the frame is pushed by the circuit substrate to come into contact with the stopper, the rib contacts the bottom of the casing and the pushing section and circuit substrate are positioned and held substantially parallel to each other.

6. The push button device according to claim 3, wherein the guide groove is formed so as to have a wider insertion side which receives the circuit substrate and tapered toward the back.

7. The push button device according to claim 4, wherein the guide groove is formed so as to have a wider insertion side which receives the circuit substrate and tapered toward the back.
